(19) United States
(12) Patent Application Publication
(10) Pub. No.: US 2013/0163576 A1
(43) Pub. Date: Jun. 27, 2013

(54) Communication Devices and Methods for Sending a Message

(71) Applicants: Haiguang Wang, Singapore (SG); Zhongding Lei, Singapore (SG); Jaya Shankar Pathmasuntharam, Singapore (SG)

(72) Inventors: Haiguang Wang, Singapore (SG); Zhongding Lei, Singapore (SG); Jaya Shankar Pathmasuntharam, Singapore (SG)

(73) Assignee: AGENCY FOR SCIENCE, TECHNOLOGY AND RESEARCH, Singapore (SG)

(21) Appl. No.: 13/809,239

(22) PCT Filed: Jul. 8, 2011
(86) PCT No.: PCT/SG2011/000244

§ 371 Date: Mar. 8, 2013

(30) Foreign Application Priority Data
Jul. 9, 2010 (SG) 201005006-0

(51) Int. Cl. H04W 72/04

(52) U.S. Cl. CPC H04W 72/0406
USPC 370/338

(57) ABSTRACT

According to one embodiment, a communication device is described comprising a determining circuit configured to determine a measure based on the time necessary for the transmission of a message from the communication device to at least one other communication device, a comparing circuit configured to compare the determined measure with a predetermined threshold, a controller configured to decide whether the message should be sent using a collision protection mechanism based on the result of the comparison, a message generating circuit configured to generate the message and a transmitter configured to send the message in accordance with the decision.

### FIELD OF THE INVENTION

Embodiments of the invention generally relate to communication devices and methods for sending a message.

### BACKGROUND OF THE INVENTION

The IEEE 802.11 communication standard has been widely used for short range wireless access to communication networks. It can be seen as a complementary technology to the wired Local Area Network (LAN). However, compared to the wired communication, there are more challenges when using the wireless technology. One such challenge arises due to the problem of the hidden terminal, i.e., for example, a first communication terminal is in range of an access point while it is out of range of a second communication terminal (and thus is hidden for the second communication terminal) such that the second communication terminal cannot detect transmissions by the first communication terminal and may thus carry out transmissions that collide with the transmissions of the first communication terminal. To solve this problem, according to the IEEE 802.11 communication standard, Carrier Sensing Multiple Access/Collision Avoidance (CSMA/CA) is used. Request-to-Send (RTS) messages and Clear-to-Send (CTS) messages are used for media reservation, i.e. channel reservation.

The IEEE 802.11 standard work group currently works on an amendment for the IEEE 802.11 standard. The amendment task group, referred to as 802.11ac, mainly focuses on the application of Multi-User Multi-Input-Multi-Output (MU-MIMO) technology in 802.11 based communication technology.

With the MU-MIMO technology, an IEEE 802.11 access point can send data to a plurality of communication terminals at the same time. Efficient methods are desirable that allow the plurality of stations to send back acknowledgments (ACKs) for the data while avoiding collisions, e.g. between the acknowledgements among themselves and/or between the acknowledgments and other messages, e.g. messages sent by other communication terminals.

### SUMMARY OF THE INVENTION

In one embodiment, a communication device is provided including a determining circuit configured to determine a measure based on the time necessary for the transmission of a message from the communication device to at least one other communication device, a comparing circuit configured to compare the determined measure with a predetermined threshold, a controller configured to decide whether the message should be sent using a collision protection mechanism based on the result of the comparison, a message generating circuit configured to generate the message and a transmitter configured to send the message in accordance with the decision.

### SHORT DESCRIPTION OF THE FIGURES

Illustrative embodiments of the invention are explained below with reference to the drawings.

FIG. 1 shows a communication system according to an embodiment.

FIG. 2 shows a communication arrangement and a message flow diagram.

FIG. 3 shows a message flow diagram.

FIG. 4 shows a message flow diagram according to an embodiment.

FIG. 5 shows a communication arrangement and a message flow diagram.

FIG. 6 shows a message flow diagram according to an embodiment.

FIG. 7 shows a communication device according to an embodiment.

FIG. 8 shows a flow diagram according to an embodiment.

FIG. 9 shows a message flow diagram according to an embodiment.

FIG. 10 shows a communication device according to an embodiment.

FIG. 11 shows a flow diagram according to an embodiment.

FIG. 12 shows a message flow diagram.

### DETAILED DESCRIPTION

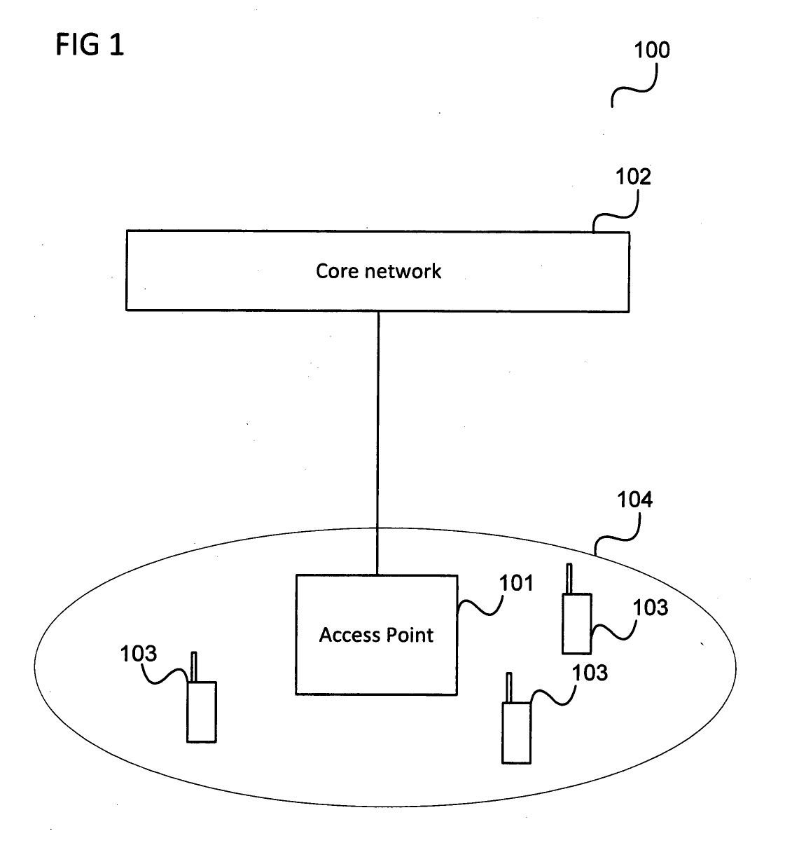

FIG. 1 shows a communication system 100 according to an embodiment.

The communication system 100 includes an access point 101. The access point 101 provides wireless access to a core 102 network for a plurality of communication terminals 103 in its coverage area 104. The communication terminals 103 that want to be provided with access by the access point 101 are attached to the access point 101.

The access point 101 is for example an access point according to IEEE 802.11.

In one embodiment, the access point 101 and the communication terminals 103 use a common communication channel for exchanging data. To avoid collisions between messages transmitted by different communication devices, Request-to-Send (RTS) messages and Clear-to-Send (CTS) may be used to reserve usage of the channel.

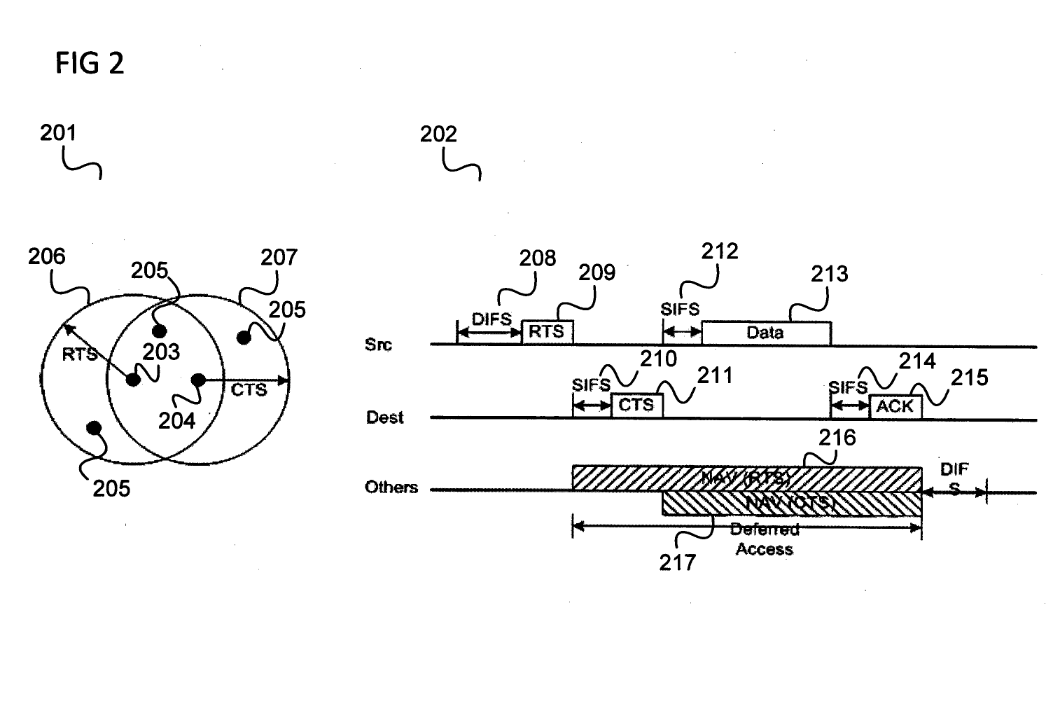

This is illustrated in FIG. 2.

FIG. 2 shows a communication arrangement 201 and a message flow diagram 202.

The communication arrangement 201 includes a source communication device 203 (of data to be transmitted) for example corresponding to a first one of the access point 101 and the communication terminals 103, a destination communication device 204 (for the data to be transmitted) for example corresponding to a second one of the access point 101 and the communication terminals 103, and other communication devices 205 for example corresponding to the remainder of the access point 101 and the communication terminals 103.

In the message flow diagram 202, time increases from left to right.

After a DIFS (Distributed Interframe Space) 208, the source communication device 203 sends an RTS (Ready-to-Send) message 209. After a first SIFS (Short Interframe Space) 210, the destination communication device 204 responds with a CTS (Clear-to-Send) message 211. After a second SIFS 212, the source communication device 203 sends the data 213 to be transmitted. After a third SIFS 214, the destination communication device sends an acknowledgment (ACK) message 215.

The other communication devices may not access the communication channel during data 213 transmission and ACK message 215 transmission as indicated by a first hatched block 216 and a second hatched block 217.

A communication terminal of the other communication terminals 205 that receives the RTS message 209 knows that it may not access the channel for the period after the RTS message 209 until the acknowledgement 215 was sent as indicated by the first hatched block 216.

A communication terminal of the other communication terminals 205 that receives the CTS message 211 knows that it may not access the channel for the period after the CTS message 211 until the acknowledgement 215 was sent as indicated by the second hatched block 217.

The transmission range of the RTS message 209 is indicated by a first circle 206 and the transmission range of the CTS message 211 is indicated by a second circle 207. As can be seen, communication terminals 205 may exist that do not receive the RTS message 209 or the CTS message 211 which may thus try to access the channel and cause a collision.

According to one embodiment, the access point 101 uses Multi-User Multiple-Input-Multiple-Output (MU-MIMO) to send data to a plurality of the communication devices 103.

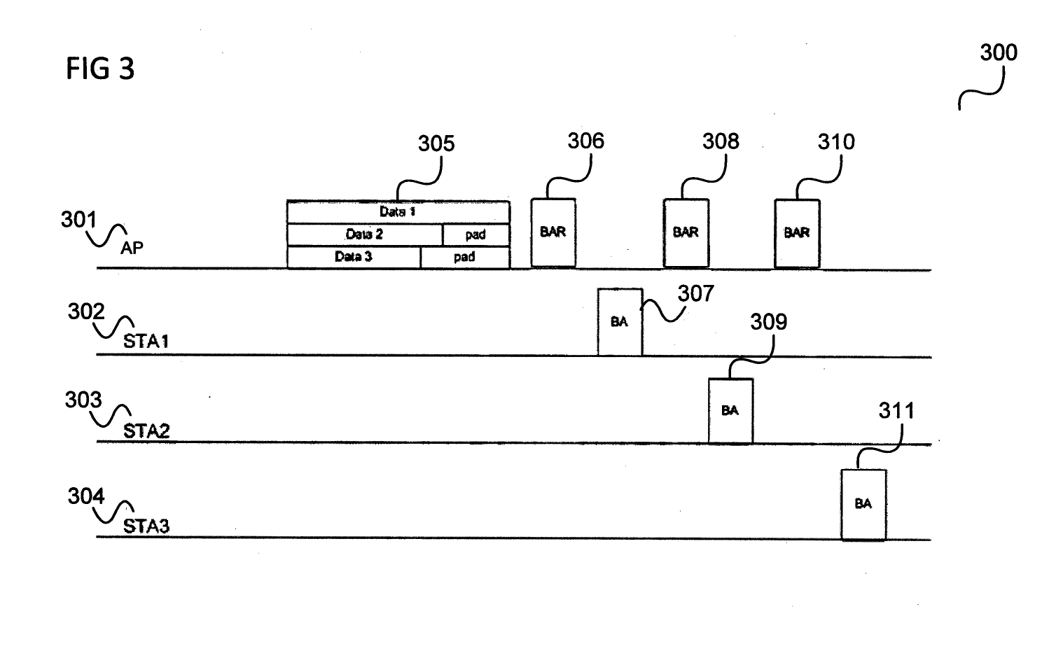

In this case, each of the plurality of communication devices 103 sends an acknowledgement message. The acknowledgements may be sent in accordance with a polling by the access point 101. This is illustrated in FIG. 3.

FIG. 3 shows a message flow diagram 300.

The message flow is illustrated for an access point 301 for example corresponding to the access point 101 and a first communication terminal 302, a second communication terminal 303 and a third communication terminal 304 for example corresponding to the communication terminals 103. Time increases from left to right.

The access point 301 sends out the data to be transmitted to the communication terminals 301, 302, 303 in a data transmission 305. The data transmission 305 involves simultaneous transmission of the data directed to the first communication terminal 301, the data directed to the second communication terminal 302 and the data directed to the third communication terminal 303.

If the data amounts to be sent to the communication terminals 301, 302, 303 are not the same, the data may be padded such that the data transmission 305 has the same length for each transmit antenna.

After the data transmission 305 is finished, the access point 301 sends out a first BAR message (Block Acknowledgement Request) 306 to the first communication terminal 301 and the first communication terminal 301 sends back a first BA (Block Acknowledgement) message 307 accordingly. Other communication terminals (including the second communication terminal 302 and the third communication terminal 303) do not transmit anything when having received the first BAR message 306 from the access point 301.

Similarly, (only) the second communication terminal 302 responds to a second BAR message 308 with a second BA message 309 and (only) the third communication terminal 303 responds to a third BAR message 310 with a third BA message 311 while the other remaining communication terminals receiving the BAR messages 308, 309 do not access the channel (for the time reserved for the transmission of the response BA messages 309, 310).

For a single hop wireless LAN system, all communication terminals 103 under the coverage 104 of the access point 101 can hear the BAR messages 306, 308, 310. Therefore, there can be no hidden terminal for the BAR transmission and thus collisions in acknowledgment transmission due to hidden terminals can be avoided. Further, this is compatible with the legacy IEEE 802.11 system.

It should be noted that the data directed to the communication terminals 301, 302, 303 can specify an implicit BAR for one of the communication terminals 301, 302, 303 such that one of the BAR messages 306, 307, 308 does not need to be transmitted. In this case, the communication terminal 301, 302, 303 for which an implicit BAR has been specified responds with a BA message 307, 308, 309 after the data transmission 305 without waiting for a BAR message.

The polled ACK approach as described with reference to FIG. 3 however introduces a relatively high amount of overhead due to the exchange of BAR messages 306, 307, 308 and BA messages 307, 309, 311.

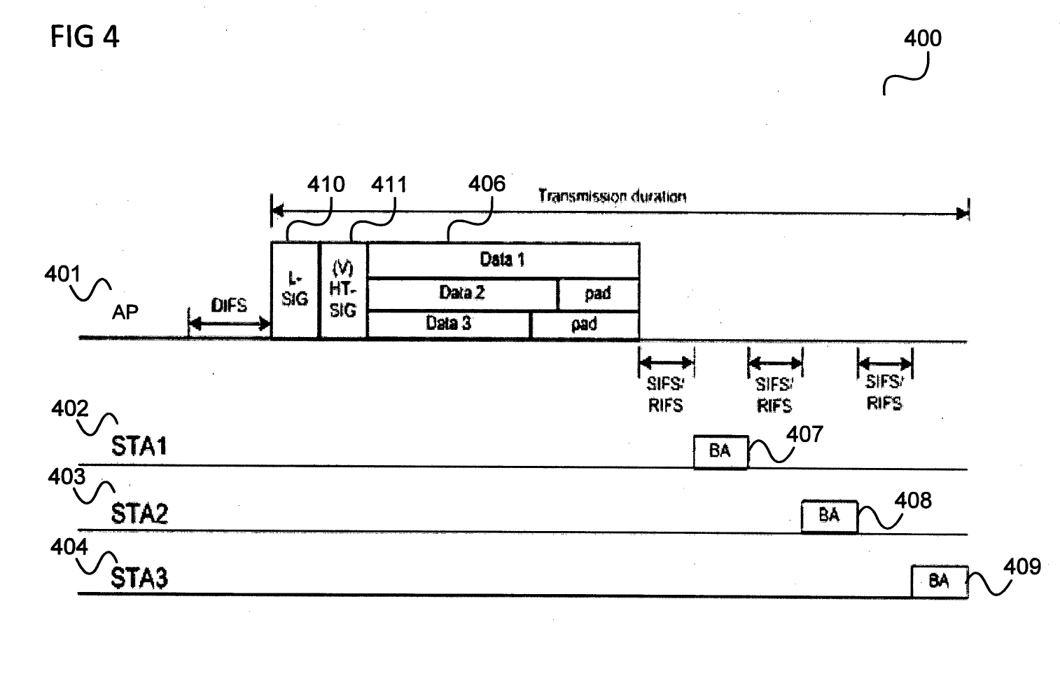

The overhead may be reduced by using the scheduled ACK approach as illustrated in FIG. 4.

FIG. 4 shows a message flow diagram 400 according to an embodiment.

The message flow is illustrated for an access point 401 for example corresponding to the access point 101 and a first communication terminal 402, a second communication terminal 403 and a third communication terminal 404 for example corresponding to the communication terminals 103. Time increases from left to right.

Similarly to the data transmission 305, the access point 401 carries out a data transmission 406. The data transmission 406 is in this example preceded by an L-SIG (Legacy Signal field) 410 and a (V)HT-SIG ((Very) High Throughput Signal field) 411.

After the data transmission 406, each communication terminal 402, 403, 404 sends back a BA message 407, 408, 409. The time of transmission of the BA messages 407, 408, 409 may for example be given by respective offsets specified in the data transmitted to the communication terminals 402, 403, 404. For example, an implicit BAR and no offset may be specified for the first communication terminal 402, an implicit BAR and a first offset may be specified for the second communication terminal 403 and an implicit BAR with a second (larger) offset may be specified for the third communication terminal 404. Collision of acknowledgement messages is avoided by using different offsets.

It should be noted that when a communication terminal 402, 403, 404 does not correctly receive the data transmission 406 the case may occur that the communication terminal 402, 403, 404 does not send its BA message 407, 408, 409 which may lead to a transmission gap. When the BA messages 407, 408, 409 are sent at certain data rates, there may not be enough time for the access point 401 to fill the transmission gap (even with a NULL frame). Thus, another communication terminal may contend for the channel during the transmission gap and access the transmission gap which may lead to a collision with a following BAR message.

Further, when a legacy IEEE 802.11 communication terminal is within the transmission range of the access point 401 (which is in this example an IEEE 802.11ac access point supporting scheduled ACK), the ACK packet (i.e. the BA message) sent by one of the communication terminals 402, 403, 404 (which are in this example IEEE 802.11ac communication terminals) may collide with data sent from the legacy communication terminal.

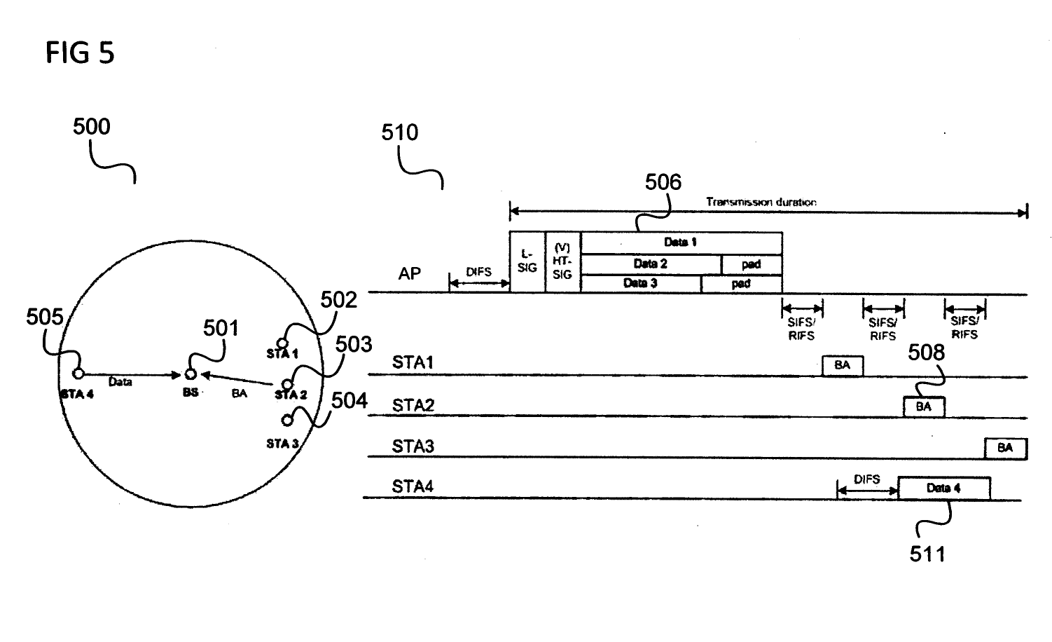

This is illustrated in FIG. 5.

FIG. 5 shows a communication arrangement 500 and a message flow diagram 510.

The communication arrangement 500 includes an access point 501 corresponding to the access point 401, a first communication terminal 502 corresponding to the first communication terminal 402, a second communication terminal 503 corresponding to the second communication terminal 402 and a third communication terminal 504 corresponding to the third communication terminal 402.

The communication arrangement 500 further includes a fourth communication terminal 505 which is assumed to be a legacy IEEE 802.11 terminal.

The message flow diagram 510 corresponds to the message flow diagram 400 but also includes the fourth communication terminal 505 as participant of the message flow.

Since the fourth communication terminal 505 does not recognize from the information transmitted in the data transmission 506 (corresponding to data transmission 406) that the communication terminals 502, 503, 504 are implicitly scheduled to transmit BA messages, it accesses the channel in this example by sending a message 511 which collides with the BA message 508 (corresponding to the second BA message 408) sent by the second communication terminal.

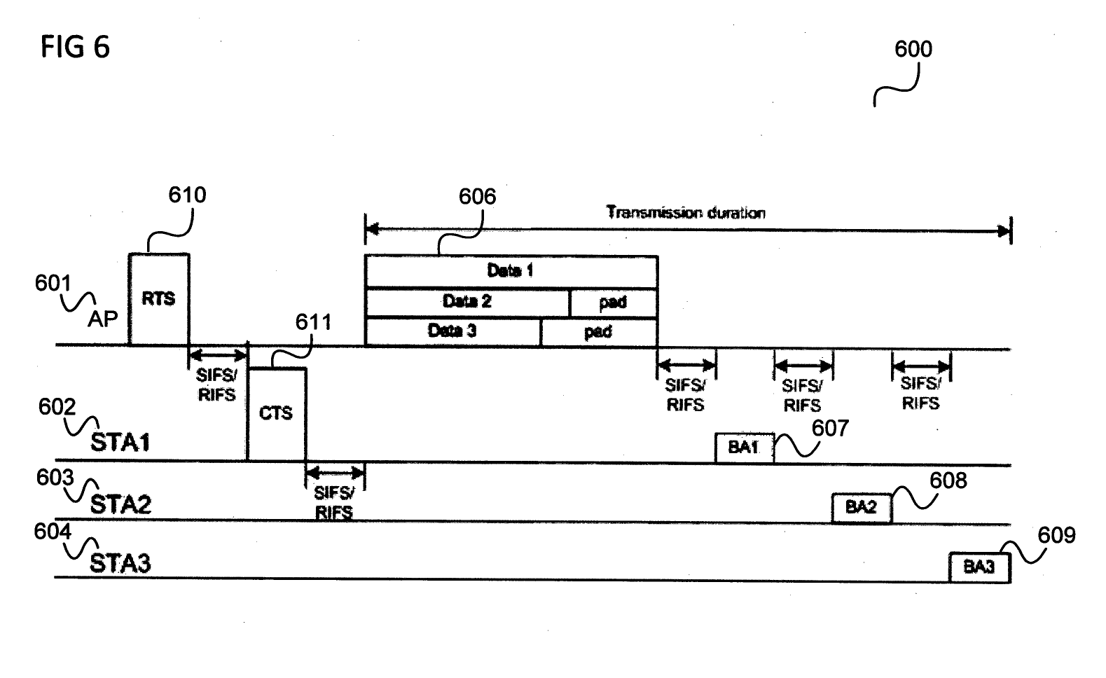

Such collisions may be avoided by using the RTS/CTS protection approach as illustrated in FIG. 6.

FIG. 6 shows a message flow diagram 600 according to an embodiment.

The message flow is illustrated for an access point 601 for example corresponding to the access point 101 and a first communication terminal 602, a second communication terminal 603 and a third communication terminal 604 for example corresponding to the communication terminals 103. Time increases from left to right.

Similarly to the data transmission 406, the access point 601 transmits data to the communication terminals 602, 603, 604 in a data transmission 606.

Before carrying out the data transmission, the access point 601 sends a RTS message 610 which is addressed to one of the communication terminals 602, 603, 604, in this example the first communication terminal 602, and waits for the reception of a corresponding CTS message 611 sent out accordingly by the first communication terminal 602. The communication terminal 602, 603, 604 to which the RTS message 610 is addressed may be randomly chosen by the access point 601.

The RTS message 610 (or also the CTS message 611) can carry information about the duration 612 of the data transmission 606 and the corresponding BA messages and a possible legacy communication terminal 103 that is in the coverage 104 of the access point 601 which receives this information will avoid accessing the channel during the specified duration 612. Thus, collision of BA messages 607, 608, 609 with data transmitted by a legacy communication terminal can be avoided.

The RTS/CTS protection mechanism as described with reference to FIG. 6 introduces overhead that may be relevant in case that the duration of the data transmission 606 is relatively short (e.g. a small amount of data is transmitted). On the other hand, the RTS/CTS protection mechanism may be of advantage when the transmission duration (also referred to as TXOP) is long and a high amount of communication terminals 103 is present in the coverage area 104. It should be noted that the exchange of the RTS message 610 and the CTS message 611 may also act as a collision detect mechanism which allows avoiding that the channel becomes unusable for a whole transmission duration of e.g. ams.

Another approach is the method is the CTS-to-Self protection. In this case, the access point 601 sends out, instead of the RTS message 610, a CTS message with its own address as destination address (referred to as CTS-to-Self message). Accordingly, no CTS message 611 is transmitted by the communication terminals 602, 603, 604 in response.

The communication terminals 103 located in the coverage are 104 stations hearing the CTS will stop using the channel, e.g. for the duration of the data transmission as indicated in the CTS message sent by the access point 601. Thus, collisions during transmission of the acknowledgements (i.e. the BA messages 607, 608, 609) can be avoided.

Thus, protection of ACK transmission for 802.11ac networks can be provided with relatively little overhead. However, the CTS-to-Self message itself may be dropped due to a collision while the data transmission 606 is successful. In such a situation, the transmission of the acknowledgements may not be protected and collisions may occur.

As another alternative to the RTS/CTS protection scheme described above with reference to FIG. 6, the access point 601 may send a respective RTS message 610 to each of the communication terminals 602, 603, 604 which each send back a CTS message 611. Although this provides good protection against collisions this introduces an amount of overhead which is typically not tolerable.

As another protection scheme, the Dummy RTS protection scheme may be used which may be seen to be similar to the CTS-to-Self scheme. However, instead of the CTS-to-Self message, the access point 101 sends a RTS message which is addressed to a MAC address that is not used by any of the communication terminals 103 attached to the access point 101.

The communication terminals 103 can still decode the packet and extract the transmission duration information included in the RTS message (which includes the duration of the transmission of the data and the acknowledgement messages). Thus, the acknowledgment messages can be protected.

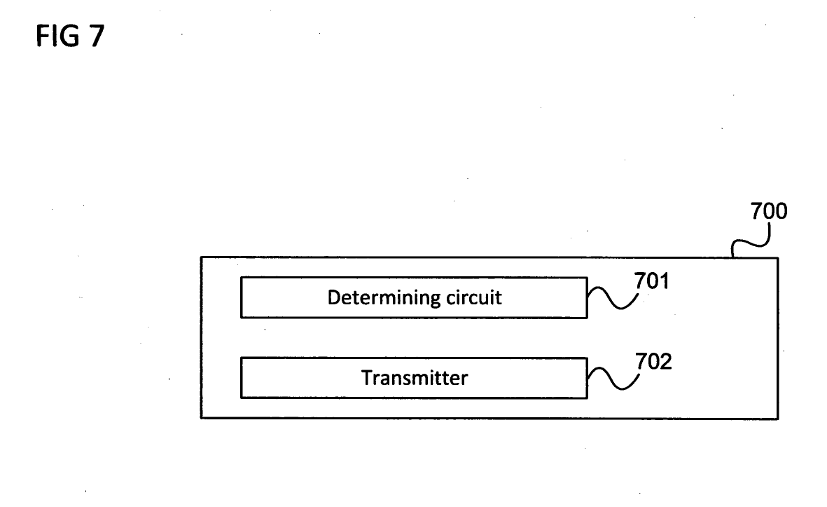

According to one embodiment, a communication device is provided as illustrated in FIG. 7.

FIG. 7 shows a communication device 700 according to an embodiment.

The communication device 700 includes a message generating circuit 701 configured to generate a message indicating that the communication device is ready to send data to each of a plurality of other communication devices, wherein the message is addressed to each communication device of the plurality of other communication devices.

The communication device 700 further includes a transmitter 702 configured to send the message to each communication device of the plurality of other communication devices.

In other words, in one embodiment, for example in case the communication device 700 is operating as an of a WLAN, e.g. according to IEEE 802.11, the communication device 700 sends the same RTS message to a plurality of communication terminals located in its coverage area. The corresponding CTS messages that are sent back by all of the communication terminals can be received by further communication terminals which are thus informed that a data transmission is planned and that they should not access the communication resources used for the data transmission (e.g. the communication channel).

The message is for example a Ready-to-Send message.

In one embodiment, the message requests each communication device of the plurality of other communication devices to transmit a response message indicating that the other communication device is ready to receive the data.

In one embodiment, the message is transmitted according to a communication protocol according to which the plurality of other communication devices transmit a response message to the message indicating that the other communication device is ready to receive the data. For example, the message is transmitted in accordance with the protocol according to IEEE 802.11 or IEEE 802.11 ac.

The response message is for example a Clear-to-Send message.

The communication device may further include a receiver configured to receive, for each communication device of the plurality of other communication devices, the response message sent by the other communication device.

The communication device may further include a transmitter configured to transmit the data after a predetermined time period after the transmission of the message.

According to one embodiment, the transmitter is configured to transmit the data to the plurality of other communication devices using MIMO.

According to one embodiment, the transmitter is configured to transmit different data to be sent to different communication devices of the plurality of other communication devices in parallel.

The data is for example transmitted according to a communication protocol requesting the plurality of other communication devices to acknowledge receipt of the data, i.e. in accordance with the protocol according to IEEE 802.11 or IEEE 802.11 ac.

In one embodiment, the communication device is an access point of a wireless communication network.

In one embodiment, the message is sent and the data is to be sent using common communication resources.

The communication resources are for example communication resources shared for data transmission from the communication device to the other communication devices and for data transmission from the other communication devices to the communication device.

The communication resources may be communication resources further shared for data transmission between the communication device and a further communication device which is not part of the plurality of other communication devices.

The communication resources are for example communication resources for which allocation to data transmission between the communication device and the further communication device may be requested by the further communication device.

In other words, the data and the message may be transmitted via a shared communication channel, as for example according to IEEE 802.11 or IEEE 802.11ac.

According to one embodiment, the message generating circuit is configured to address the message to each communication device of the plurality of other communication devices by means of a multicast MAC address associated with the plurality of other communication devices.

The multicast MAC address is for example derivable from the MAC addresses of the plurality of other communication devices, e.g. by performing a mathematical operation on the MAC addresses of the plurality of other communication devices (e.g. by combining the MAC addresses of the plurality of other communication devices using a logic operation such as an OR or an XOR operation).

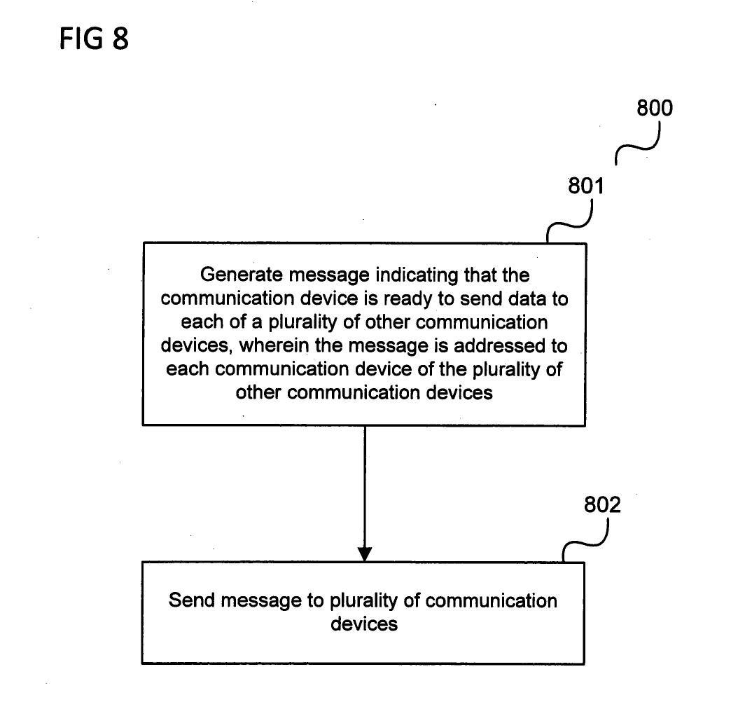

The communication device 700 for example carries out a method as illustrated in FIG. 8.

FIG. 8 shows a flow diagram 800 according to an embodiment.

The flow diagram 800 illustrates a method for sending a message.

In 801, a message is generated indicating that the communication device is ready to send data to each of a plurality of other communication devices, wherein the message is addressed to each communication device of the plurality of other communication devices.

In 802, the message is sent to each communication device of the plurality of other communication devices.

The method may further include that each of the other communication devices sends a response message to the message. The response messages are in one embodiment sent by the other communication devices simultaneously.

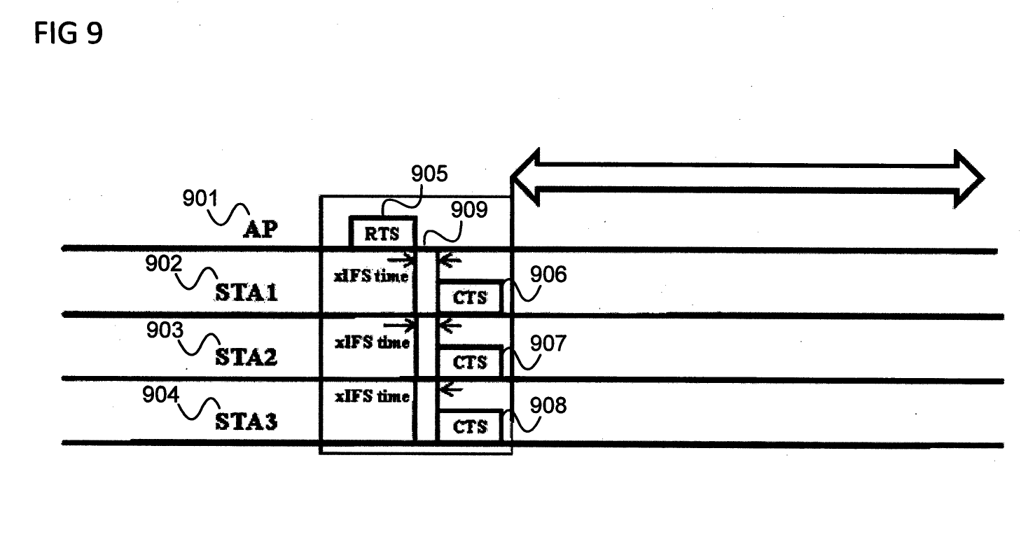

An example for the case that the communication device 700 is an access point of a WLAN, e.g. operating according to IEEE 802.11 or IEEE 802.11ac, is described with reference to FIG. 9.

FIG. 9 shows a message flow diagram 900 according to an embodiment.

The message flow is illustrated for an access point (or access point) 901 for example corresponding to the access point 101 and a first communication terminal 902, a second communication terminal 903 and a third communication terminal 904 for example corresponding to the communication terminals 103. Time increases from left to right.

The access point 901 sends an RTS message 905, which contains the MAC address of all the desired receiving communication terminals 902, 903, 904 in its coverage area.

In this example, the communication terminals 902, 903, 904 then send back CTS messages 906, 907, 908 at the same time (after an interframe space 909). The communication terminals 902, 903, 904 for example use an OFDMA (Orthogonal Frequency Division Multiple Access) communication scheme for transmitting the CTS messages 906, 907, 908, the CTS messages 906, 907, 908 may reach the access point 901 within the cyclic prefix such that the access point can decode the CTS messages 906, 907, 908.

Compared to the RTS/CTS scheme described with reference to FIG. 6, a higher protection range can be achieved due to the plurality of CTS messages 906, 907, 908, i.e. a further communication terminal can typically receive at least one of the CTS 906, 907, 908 in a bigger area than in case of transmission of a single CTS message. Thus, better protection can be expected to be achieved.

It should be noted that a relative high precision in time synchronizations among the communication terminals 902, 903, 904 may be required in the example described with reference to FIG. 9 in which the CTS messages are transmitted simultaneously.

The protection schemes described above with reference to FIGS. 5 to 9 may all be advantageous or disadvantageous depending on the scenario. For example, while some may not provide sufficient protection (e.g. incomplete protection) in a scenario where a high level of protection is required (e.g. in case of a busy network), others may introduce an overhead that is too large in another scenario (e.g. when small amounts of data are transmitted).

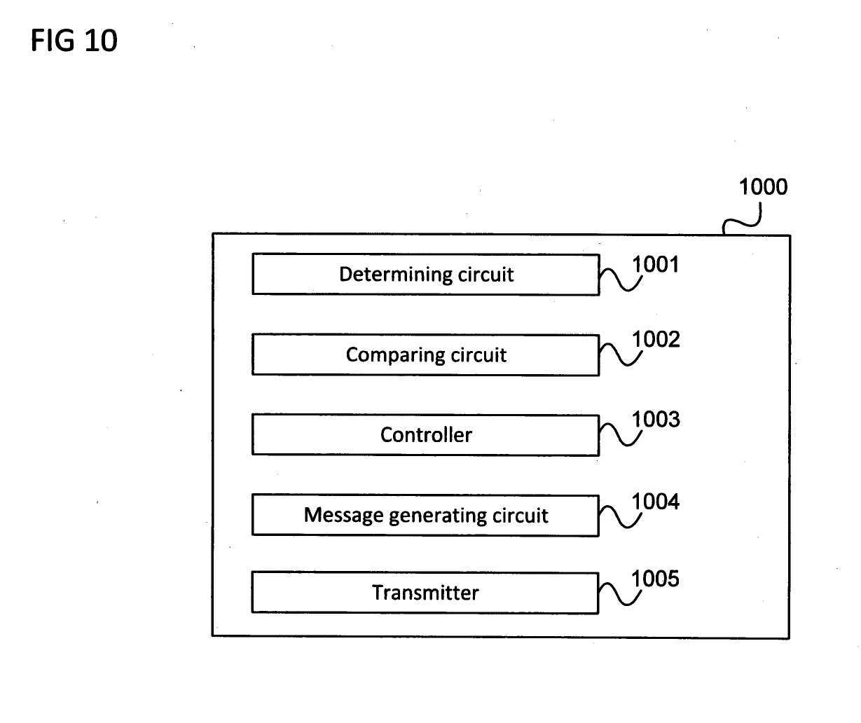

It can be found that with the scheduled ACK approach better performance in terms of overhead can be achieved than with the polled ACK approach. However, depending on the scenario, an appropriate protection scheme may be designed to protect the ACKs (acknowledgement messages) from collisions at a high level. As different protection schemes can cause different levels of overhead and different levels of protection, according to one embodiment, a method is provided according to which it is decided whether a protection scheme is used or is not used (and, instead, the scheduled ACK protection approach is used which can be seen as to provide no protection). This is illustrated in FIG. 10.

FIG. 10 shows a communication device 1000 according to an embodiment.

The communication device 1000 includes a determining circuit 1001 configured to determine a measure based on the time necessary for the transmission of a message from the communication device to at least one other communication device and a comparing circuit 1002 configured to compare the determined measure with a predetermined threshold.

Further, the communication device 1000 includes a controller 1003 configured to decide whether the message should be sent using a collision protection mechanism based on the result of the comparison.

The communication device 100 further includes a message generating circuit 1004 configured to generate the message and a transmitter 1005 configured to send the message in accordance with the decision.

In one embodiment, in other words, the required time for carrying out the transmission of a message (or data) to be sent is determined and based on the determined required time, it is decided whether a certain protection scheme is used in the transmission of the message or not. This may involve determining from the determined required time the relative overhead introduced by the collision protection mechanism (e.g. in terms of an increase of time required for the transmission process when using the collision protection mechanism). The relative overhead may then be compared with the threshold to determine whether the collision protection mechanism is used. In other words, the measure may be a relative overhead. Alternatively, the measure may be the measured required time itself such that the required time may be compared with the threshold and it is decided based on the result of the comparison whether a certain protection mechanism (or any protection mechanism at all) is used for the message transmission. Generally, the measure can be seen as a transmission time measure (e.g. a measure of an overhead of transmission time, e.g. in terms of a relative increase, e.g. given in percent or an absolute measure of a transmission time necessary for the transmission of data).

The threshold can for example be set statically via a configuration tool. According to one embodiment, the threshold can be updated dynamically in accordance with an intelligent algorithm. For example, the threshold may be updated in accordance with a criterion, e.g. based on the network load.

The collision protection mechanism (alternatively referred to as collision protection scheme, channel protection scheme/mechanism or channel access collision avoidance scheme/mechanism) is for example one of the protection schemes described above with reference to FIGS. 5 to 9, e.g. RTS/CTS protection, CTS-to-Self protection, Dummy RTS protection, or Single RTS Multiple CTSs protection or also the polled ACK scheme.

In one embodiment, the selection of the (collision) protection scheme is based on comparison with a single threshold method. In this case, the protection scheme may for example be selected based on the overhead, which may be calculated according to the overall transmission time required with/without usage of the protection scheme, the overall transmission time including the transmission time for the data, the RTS/CTS (if applicable), and the ACK messages.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

With the message, data is for example to be sent the at least one other communication device.

The at least one other communication device is for example a communication terminal.

In one embodiment, the controller is configured to decide whether the message should be sent using a collision protection mechanism or without using a collision protection mechanism.

In one embodiment, the measure is a measure of the time necessary for the transmission of the message.

In one embodiment, the measure is a measure of the overhead introduced to the transmission of the message when using the collision protection mechanism.

The determining circuit is for example configured to determine the measure based on the time necessary for a including the transmission of data to each communication device of a plurality of other communication devices including the at least one other communication device, wherein a message is to be sent to each communication device of the plurality of other communication devices and wherein the controller is configured to decide whether the messages should be sent using a collision protection mechanism based on the result of the comparison, the message generating circuit is for example configured to generate, for each communication device of the plurality of other communication devices a message including the data to be sent to the communication device, and the transmitter is for example configured to send the messages in accordance with the decision.

The transmitter may be configured to transmit the messages to the plurality of other communication devices simultaneously.

and/or may be configured to transmit the messages to the plurality of other communication devices using MIMO.

According to one embodiment, the measure is a measure of the overhead introduced to the data transmission when using the collision protection mechanism.

The transmitter is configured to send the message using communication resources shared for data transmission from the communication device to the at least one other communication device and for data transmission from the at least one other communication device to the communication device.

The communication resources may be communication resources further shared for data transmission between the at least one communication device and a further communication device.

The communication resources may be communication resources for which allocation to data transmission between the communication device and the further communication device may be requested by the further communication device.

The communication device is for example an access point of a wireless communication network, e.g. according to IEEE 802.11 or IEEE 802.11ac.

In one embodiment, the controller is a component of the data link layer, for example of the MAC (Medium Access Control) layer.

According to one embodiment, the comparing circuit is configured to compare the determined measure with the predetermined threshold and with another predetermined threshold and determine based on whether the measure is below both of the thresholds, between the two thresholds or above both of the thresholds, whether the collision protection mechanism, another collision protection mechanism or no collision protection mechanism should be used. In other words, in various embodiments, the measure may be compared with two or more thresholds to select the protection scheme.

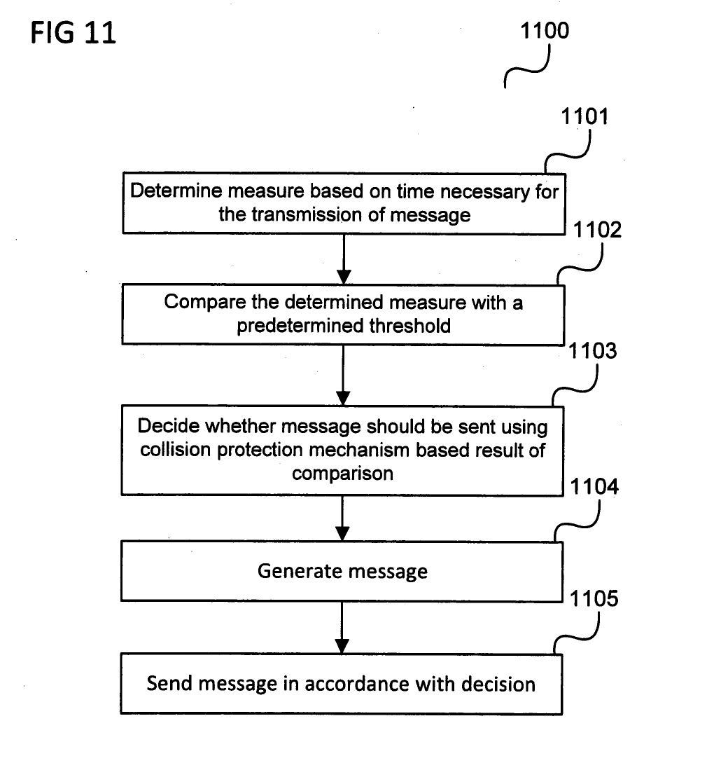

The communication device 1000 for example carries out a method as illustrated in FIG. 11.

FIG. 11 shows a flow diagram 1100 according to an embodiment.

The flow diagram 1100 illustrates a method for sending a message.

In 1101, a measure based on the time necessary for the transmission of a message from the communication device to at least one other communication device is determined.

In 1102, the determined measure is compared with a predetermined threshold.

In 1103, it is decided whether the message should be sent using a collision protection mechanism based on the result of the comparison.

In 1104, the message is generated

In 1105, the message is sent in accordance with the decision.

It should be noted that embodiments described in context with one of the communication devices according to FIGS. 7 and 10 are analogously valid for the other communication device and the methods for sending a message according to FIGS. 8 and 11 and vice versa.

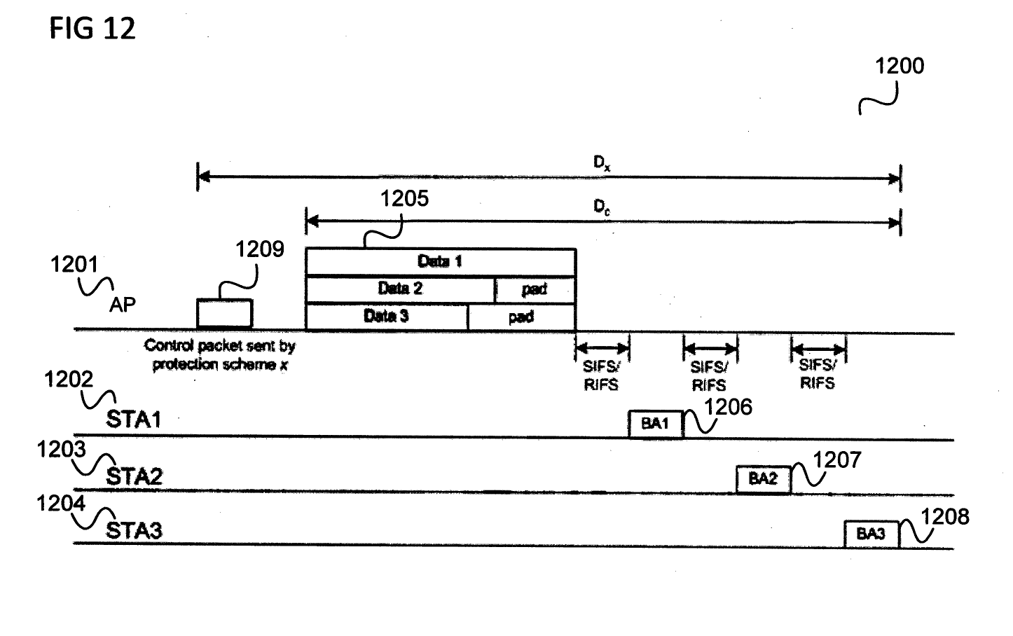

An example for the decision whether a (collision) protection mechanism is to be used is described in the following with reference to FIG. 12.

FIG. 12 shows a message flow diagram 1200.

The message flow is illustrated for an access point 1201 for example corresponding to the access point 101 and a first communication terminal 1202, a second communication terminal 1203 and a third communication terminal 1204 for example corresponding to the communication terminals 103. Time increases from left to right.

The access point 1201 sends out the data to be transmitted to the communication terminals 1201, 1202, 1203 in a data transmission 1205. The data transmission 1205 involves simultaneous transmission of the data directed to the first communication terminal 1201, the data directed to the second communication terminal 1202 and the data directed to the third communication terminal 1203. For each communication terminal 1201, 1202, 1203, the data directed to the communication terminal 1201, 1202, 1203 may be sent via a respective associated transmit antenna of the access point 1201.

In one embodiment, it is decided whether a collision protection mechanism is used based on the overhead that would be introduced when using the collision protection mechanism. Thus, the amount of overhead can be controlled, i.e. it can for example be ensured that no collision protection mechanism is used such that the overhead introduced exceeds the threshold. The introduced overhead is in this example caused by a message 1209, for example a control packet which is sent by the access point 1201 in accordance with the collision protection mechanism.

For example, a threshold value is set up (i.e. predetermined) which is in this example denoted as H₀. Given the overhead measured for a protection scheme is greater than H₀, then the protection scheme is not used. Else, the protection scheme is used.

The overhead is for example calculated as follows. The transmission duration of scheduled ACK without any protection D₀ is determined which includes both the duration of the data transmission 1205 and the time necessary for the transmission of acknowledgement messages 1206, 1207, 1208 from the communication terminals 1202, 1203, 1204. Further, the transmission duration required when using a certain protection scheme (“protection scheme x”) Dₓ is also determined (e.g. the transmission time D₀ plus the time necessary for the transmission of the message 1209). Then the (relative) overhead for protection scheme x, denoted as Hₓ, is determined using the following equation:

$${H}_{x} = \frac{{D}_{x} - {D}_{0}}{{D}_{0}} . \qquad ( 1 )$$

In one embodiment, in case that for more than one protection scheme the determined overhead is below the threshold, the access point 1201 can for example choose the protection scheme among these protection schemes that maximizes the protection or choose the protection scheme among these protection schemes that introduces the least overhead.

In another embodiment, a protection scheme is chosen based on the transmission duration D₀ directly. For example a sequence of two or more threshold values is predetermined for choosing a protection scheme. The access point 1201 may compare the transmission duration with the threshold values to determine a protection scheme from a plurality of protection scheme.

For example, the access point 1201 chooses among two protection schemes, the CTS-To-Self protection scheme and the RTS/CTS protection schemes, as protection for the scheduled ACK scheme. The overhead of CTS-to-Self protection is relatively small but it offers only relatively limited protection. RTS/CTS protection can provide better protection but introduces a larger overhead.

Accordingly, according to one embodiment, to optimize the system performance, two thresholds are predetermined, denoted as L₁ and L₂ (with L₁<L₂) for the protection scheme selection. When the transmission duration D₀ is shorter than L₁, then the access point 1201 uses no protection scheme is used (i.e. scheduled ACK scheme without protection). When L₁<D₀<L₂, the access point 1201 chooses CTS-to-Self protection (or, for example, Dummy RTS protection). When D₀>L₂, the access point 1201 chooses the RTS/CTS protection scheme for the protection of the transmission.

In one embodiment, when CTS-to-Self protection is used and the CTS-to-Self message is not transmitted successfully but the data are transmitted successfully to the communication terminals, the polled ACK scheme is used.

It should be noted that one of the design considerations for a MU-MIMO scheme is to address the receiving stations (i.e. receiving communication terminals in the above examples) correctly during a data transmission. One approach is to include additional fields in the RTS message to address the set of receiving stations properly. However, in with this approach, the number of stations that is addressable could be limited by the number of new address fields. Further, it may be undesirable to extend the size of the RTS message to much as this incurs additional overhead. This issue may be of relevance in case that according to the MU-MIMO scheme only a single RTS message is used for a single burst of a data transmission cycle. Therefore, it may be desirable to keep the address field to a single receiving address.

According to one embodiment, each station has its unique MAC address. The destination MAC address included in the RTS message is replaced with a multicast address that represents a set of stations that the sender node (e.g. the access point in the above examples) wants to address. This multicast address can be a pre-agreed address or based on a mathematical formula that takes several MAC addresses as inputs and generates a new MAC address that is not the same as any of the MAC address belonging to communication terminals that are attached to the same access point.

According to one embodiment, a method is for example based on simply performing a mathematical operation such as OR/XOR on all the valid MAC address of the intended receivers. For example, according to the MU-MIMO scheme, the MAC address of all stations that are attached to the same access point are kept (e.g. in a neighbor table). After receiving an RTS message, a receiving station tries to decode the multicast address by checking the list of MAC addresses in its neighbor table. The receiving station iteratively checks if its original MAC address has been used to derive the multicast address. If a receiving station detects this, it knows that the sending station (e.g. the access point) intends to send data to the receiving station. The receiving station may then send a CTS message to confirm the MAC transaction.

1. A communication device comprising:
a determining circuit configured to determine a measure based on the time necessary for the transmission of a message from the communication device to at least one other communication device;
a comparing circuit configured to compare the determined measure with a predetermined threshold;
a controller configured to decide whether the message should be sent using a collision protection mechanism based on the result of the comparison;
a message generating circuit configured to generate the message; and
a transmitter configured to send the message in accordance with the decision.

2. The communication device according to claim 1, wherein with the message, data is to be sent to at least one other communication device.

3-4. (canceled)

5. The communication device according to claim 1, wherein the measure is a measure of the time necessary for the transmission of the message.

6. The communication device according to claim 1, wherein the measure is a measure of the overhead introduced to the transmission of the message when using the collision protection mechanism.

7. The communication device according to claim 1,
wherein the determining circuit is configured to determine the measure based on the time necessary for including the transmission of data to each communication device of a plurality of other communication devices including the at least one other communication device,
wherein a message is to be sent to each communication device of the plurality of other communication devices and wherein the controller is configured to decide whether the messages should be sent using a collision protection mechanism based on the result of the comparison;
wherein the message generating circuit is configured to generate, for each communication device of the plurality of other communication devices a message including the data to be sent to the communication device; and
wherein the transmitter is configured to send the messages in accordance with the decision.

8. The communication device according to claim 7, wherein the transmitter is configured to transmit the messages to the plurality of other communication devices simultaneously.

9. The communication device according to claim 7, wherein the transmitter is configured to transmit the messages to the plurality of other communication devices using MIMO.

10. The communication device according to claim 1, wherein the measure is a measure of the overhead introduced to the data transmission when using the collision protection mechanism;

11. The communication device according to claim 1, wherein the transmitter is configured to send the message using communication resources shared for data transmission from the communication device to the at least one other communication device and for data transmission from the at least one other communication device to the communication device.

12-15. (canceled)

16. The communication device according to claim 1, wherein the comparing circuit is configured to compare the determined measure with the predetermined threshold and with another predetermined threshold and determine based on whether the measure is below both of the thresholds, between the two thresholds or above both of the thresholds, whether the collision protection mechanism, another collision protection mechanism or no collision protection mechanism should be used.

17. A method for sending a message comprising:
determining a measure based on the time necessary for the transmission of a message from the communication device to at least one other communication device;
comparing the determined measure with a predetermined threshold;
deciding whether the message should be sent using a collision protection mechanism based on the result of the comparison;
generating the message; and
sending the message in accordance with the decision.

18. A communication device comprising
a message generating circuit configured to generate a message indicating that the communication device is ready to send data to each of a plurality of other communication devices, wherein the message is addressed to each communication device of the plurality of other communication devices;
a transmitter configured to send the message to each communication device of the plurality of other communication devices.

19. The communication device according to claim 18, wherein the message is a Ready-to-Send message.

20. The communication device according to claim 18, wherein the message requests each communication device of the plurality of other communication devices to transmit a response message indicating that the other communication device is ready to receive the data.

21. The communication device according to claim 18, wherein the message is transmitted according to a communication protocol according to which the plurality of other communication devices transmit a response message in response to the message, wherein the response message indicates that the other communication device is ready to receive the data.

22. (canceled)

23. The communication device according to claim 18, further comprising a receiver configured to receive, for each communication device of the plurality of other communication devices, the response message sent by the other communication device.

24. The communication device according to claim 18, further comprising a transmitter configured to transmit the data after a predetermined time period after the transmission of the message.

25. The communication device according to claim 24, wherein the transmitter is configured to transmit the data to the plurality of other communication devices using MIMO.

26. The communication device according to claim 24, wherein the transmitter is configured to transmit different data to be sent to different communication devices of the plurality of other communication devices in parallel.

27-28. (canceled)

29. The communication device according to claim 18, wherein the message is sent and the data is to be sent using common communication resources.

30-37. (canceled)
